(19) United States
(12) Patent Application Publication
(10) Pub. No.: US 2014/0258104 A1
(43) Pub. Date: Sep. 11, 2014

(54) AUTOMATIC PAYMENT COMPONENT FOR AN ELECTRONIC INVOICE PAYMENT SYSTEM

(71) Applicant: BOTTOMLINE TECHNOLOGIES (DE) INC., Portsmouth, NH (US)

(72) Inventor: Jeffrey M. HARNISCH, Hooksett, NH (US)

(73) Assignee: Bottomline Technologies (DE) Inc., Portsmouth, NH (US)

(21) Appl. No.: 13/786,794

(22) Filed: Mar. 6, 2013

(51) Int. Cl. G06Q 20/10

(52) U.S. Cl. CPC G06Q 20/102
USPC 705/40

(57) ABSTRACT

An automatic invoice payment system includes a database stored on a non-transitory computer readable medium, the database including a plurality of records, each record corresponding to an invoice issued by a vendor for payment from a buyer. A network interface is configured to receive presented invoices from multiple vendors for payment by multiple buyers, wherein the presented invoices are stored in the database. The processor is configured to analyze each invoice that has been presented to determine whether the presented invoice satisfies one or more predetermined rules, and when the processor determines that the presented invoice satisfies the one or more predetermined rules, to automatically set a payment initiation date upon which payment of the presented invoice is to be automatically initiated. The processor may be configured to perform such operations by the execution of an automatic payment application stored on the non-transitory computer readable medium.

### TECHNICAL FIELD

The present invention relates to an electronic invoice payment system, and more particularly to systems and methods for generating efficient automatic payment in such an electronic invoice payment system without the need for time consuming approval processes.

### BACKGROUND OF THE INVENTION

Traditional invoice presentment and payment solutions between vendors and their buyers include paper-based invoice presentment and payment. In this scenario, the steps required to send an invoice (on the vendor's side), and receive, approve, and pay the invoice (on the buyer's side) rely on a series of paper-based procedures. Recently, electronic invoicing and payment systems have been developed that provide on-line and network based invoice presentment by the vendor, and electronic funds transfer (EFT) payment by the buyer.

In electronic invoice and payment systems, vendors still issue and present invoices to buyers (also referred to herein as payers). Once a buyer receives a presented invoice, the buyer commonly subjects such invoice to an internal approval process before payment is initiated. Upon approving the invoice, the buyer then initiates the payment. The buyer also typically selects the method or system of payment. Approval and payment initiation in conventional systems, therefore, tend to be under the buyer's auspices and control. This has certain disadvantages for vendors. It is not uncommon for invoice approval to take a varying time period, which can render it difficult for vendors to predict upcoming income and cash flow.

Furthermore, vendors, of course, would like to obtain payments as promptly as possible, but commonly become subject to a buyer's selected processes for invoice approval and payment. Any delay in which a vendor has not received payment results in an actual loss to the vendor. Particularly for vendors who may often receive high value payments, the accumulation of losses resulting from the delays from invoice presentment to payment settlement can be substantial in total. In many cases, buyer approval of a presented invoice should be relatively assured, and yet the approval process still results in a delay from invoice presentment to payment. Conventional electronic invoice and payment systems, therefore, are deficient in that vendors lack control over receiving invoice payments via the most timely and efficient manner that may be available.

### SUMMARY OF THE INVENTION

There is a need in the art for an improved electronic invoice system and related methods that provide automatic payments to vendors in a more efficient and predictable manner as compared to conventional payment systems. The present invention provides for an automatic payment system, in which the presentment of an invoice by a vendor for payment by a buyer automatically will trigger payment initiation. In exemplary embodiments, the presented invoice is analyzed by an automatic payment system for compliance with one or more automatic payment rules established relative to the buyer. If the presented invoice satisfies the one or more rules, a payment initiation date is set automatically for a date certain as measured from the date of invoice presentment (e.g., three days from presentment, seven days from presentment, or like). In this manner, payment to the vendor will be initiated automatically on the set date without the invoice having to be subject to an approval process of the buyer. The system, therefore, is an automatic payment system in that payment is initiated by the payment demand of the vendor (i.e., by the invoice presentment) without further action by the buyer.

In exemplary embodiments of the automatic payment system, the setting of the payment initiation date also triggers a notification to at least the buyer (and preferably the vendor also), so that the buyer is informed that a presented invoice will be paid on the set payment initiation date. Should the buyer determine that the payment is somehow unusual or problematic, the buyer has the capacity before the payment initiation date to withdraw the invoice from automatic payment, and thus cancel the set payment initiation date. The onus, however, is on the buyer to prevent payment under such circumstances, or the payment will proceed as set. The vendor, therefore, in contrast to conventional systems, in most cases will not be subject to the buyer's approval process for payment, insofar as automatic payment initiation would be the norm for any presented invoice that satisfies the one or more rules for automatic payment.

An aspect of the invention, therefore, is an automatic invoice payment system. Exemplary embodiments of the automatic invoice payment system include a database stored on a non-transitory computer readable medium, the database including a plurality of records, each record corresponding to an invoice issued by a vendor for payment from a buyer. A network interface is configured to receive presented invoices from multiple vendors for payment by multiple buyers, wherein the presented invoices are stored in the database. A processor is configured to associate each invoice that is presented from a vendor with a buyer for payment, and to provide electronic access to one or more of the invoices by an associated buyer. The processor further is configured to analyze each invoice that has been presented to determine whether the presented invoice satisfies one or more predetermined rules, and when the processor determines that the presented invoice satisfies the one or more predetermined rules, to automatically set a payment initiation date upon which payment of the presented invoice is to be automatically initiated.

In an exemplary embodiment of the automatic invoice payment system, the one or more predetermined rules comprises historical performance data associated with invoices that are comparable to the presented invoice based on predefined criteria.

In an exemplary embodiment of the automatic invoice payment system, the one or more predetermined rules includes that the presented invoice is a repetitive invoice presented at a time based on a preset periodic time period as to which the comparable invoices were presented.

In an exemplary embodiment of the automatic invoice payment system, the one or more predetermined rules includes that the presented invoice is within a set variation in amount as compared to the comparable invoices.

In an exemplary embodiment of the automatic invoice payment system, the one or more predetermined rules includes at least one of that the presented invoice is within a set variation in amount, or satisfies a set threshold amount.

In an exemplary embodiment of the automatic invoice payment system, the one or more predetermined rules includes that the presented invoice pertains to at least one of an approved product or service.

In an exemplary embodiment of the automatic invoice payment system, the one or more predetermined rules includes that the presented invoice pertains to a quantity of the approved product or service within a prescribed amount.

In an exemplary embodiment of the automatic invoice payment system, the one or more predetermined rules includes that the presented invoice has been presented within a specified number of days of the delivery of a product or service.

In an exemplary embodiment of the automatic invoice payment system, the one or more predetermined rules includes that the presented invoice satisfies one or more criteria that operate to validate the invoice.

In an exemplary embodiment of the automatic invoice payment system, the one or more validation criteria include at least one of validating the accuracy of an invoice calculation pertaining to the presented invoice, verifying that the presented invoice matches a corresponding purchase order, or verifying that the presented invoice is not a duplicate.

In an exemplary embodiment of the automatic invoice payment system, the one or more predetermined rules are stored in the database, and the processor is configured to access the one or more predetermined rules from the database.

In an exemplary embodiment of the automatic invoice payment system, the processor further is configured to generate a payment processing signal and transmit such signal via the network interface to an electronic invoice payment system for executing the payment automatically on the set payment initiation date.

In an exemplary embodiment of the automatic invoice payment system, the processor further is configured to generate a notification that the payment initiation date has been set, and to transmit the notification to at least the buyer via the network interface.

In an exemplary embodiment of the automatic invoice payment system, the processor is configured to generated the notification by extracting buyer information from the presented invoice.

In an exemplary embodiment of the automatic invoice payment system, the extracted information comprises at least one of a buyer identity or buyer electronic address.

In an exemplary embodiment of the automatic invoice payment system, the processor further is configured to monitor for receipt of a withdrawal command signal from the buyer.

In an exemplary embodiment of the automatic invoice payment system, the processor further is configured, when a withdrawal command signal is received from the buyer, to cancel the payment initiation date.

In an exemplary embodiment of the automatic invoice payment system, the processor further is configured to generate a cancelation notification that the payment initiation date has been canceled, and to transmit the cancelation notification to at least the vendor via the network interface.

In an exemplary embodiment of the automatic invoice payment system, the processor further is configured, when a withdrawal command signal is not received from the buyer before the set payment initiation date, to generate a payment processing signal and transmit such signal via the network interface to an electronic invoice payment system for executing the payment automatically on the set payment initiation date.

In an exemplary embodiment of the automatic invoice payment system, providing access to the buyer comprises providing access to an electronic file containing invoices from multiple vendors.

In an exemplary embodiment of the automatic invoice payment system, the processor associates each presented invoice with a buyer by extracting buyer information from the presented invoice.

Another aspect of the invention is an electronic invoice and payment system. Exemplary embodiments of the electronic invoice and payment system include the described automatic invoice payment system, and an electronic invoice payment system configured to execute the payment automatically on the set payment initiation date when the processor determines that the presented invoice satisfies the one or more predetermined rules.

Another aspect of the invention is a method of automatically processing invoice payments. Exemplary embodiments of the method include the steps of: storing on a non-transitory computer readable medium a database including a plurality of records, each record corresponding to an invoice issued by a vendor for payment from a buyer; receiving over a network interface presented invoices from multiple vendors for payment by multiple buyers, wherein the presented invoices are stored in the database; and providing an automatic payment application on a non-transitory computer readable medium, which when executed by a processor performs the steps of: associating each invoice that is presented from a vendor with a buyer for payment; providing electronic access to one or more of the invoices by an associated buyer; analyzing each invoice that has been presented to determine whether the presented invoice satisfies one or more predetermined rules; and when the presented invoice is determined to satisfy the one or more predetermined rules, automatically setting a payment initiation date upon which payment of the presented invoice is to be automatically initiated.

In an exemplary embodiment of the method of automatically processing invoice payments, the automatic payment application when executed by the processor further performs the steps of: generating a notification that the payment initiation date has been set; transmitting the notification to at least the buyer via the network interface; monitoring for receipt of a withdrawal command signal from the buyer; and when a withdrawal command signal is received from the buyer, canceling the payment initiation date.

In an exemplary embodiment of the method of automatically processing invoice payments, the automatic payment application when executed by the processor further performs the steps of: when a withdrawal command signal is not received from the buyer before the set payment initiation date, generating a payment processing signal and transmitting such signal via the network interface to an electronic invoice payment system for executing the payment automatically on the set payment initiation date.

A number of features are described herein with respect to embodiments of the invention. It will be appreciated that features described with respect to a given embodiment also may be employed in connection with other embodiments. In addition, for a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is a schematic block diagram depicting an exemplary architecture of an electronic invoice presentment and payment system, including an exemplary automatic payment system, in accordance with an exemplary embodiment of the present invention.

FIG. 2 is a schematic block diagram representing a buyer system in accordance with an exemplary embodiment of the present invention.

FIG. 3 is a schematic block diagram representing a vendor system in accordance with an exemplary embodiment of the present invention.

FIG. 4A is a diagram representing an invoice database structure in accordance with an exemplary embodiment of the present invention.

FIG. 4B is a diagram representing an invoice database object in accordance with an exemplary embodiment of the present invention.

FIG. 5 is a flow chart diagram depicting an overview of an exemplary method of automatically processing invoice payments in an invoice payment system.

FIG. 6 is a flow chart diagram depicting an overview of a modified exemplary method of automatically processing invoice payments in an invoice payment system.

FIG. 7 is a diagram depicting an exemplary graphical user interface (GUI) for use in connection with an invoice payment system.

FIG. 8 is a ladder diagram depicting an exemplary embodiment of operation of an automatic invoice payment system for automatically processing invoice payments in an invoice payment system.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions that are encoded within non-transitory computer readable media accessible to the processor, or a combination of a hardware circuit(s) and a processor or control block of an integrated circuit executing machine readable code encoded within a non-transitory computer readable medium. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a non-transitory computer readable medium, or a combination of a hardware circuit(s) and a processor and/or control block executing such code.

The present invention provides a system and method for providing an automatic payment to a vendor from a payer or buyer. In exemplary embodiments, an automatic payment system within an electronic invoice presentment and payment system analyzes a presented invoice for compliance with one or more automatic payment rules established relative to the buyer. If the automatic payment system determines that the invoice satisfies the one or more automatic payment rules, a payment initiation date is set automatically for a date certain as measured from the date of invoice presentment. Upon such payment initiation date, payment to the vendor will be initiated automatically on the set date without the invoice having to be subject to an approval process of the buyer.

In exemplary embodiments of the automatic payment system, the system, upon setting the payment initiation date, transmits a notification to at least the buyer (and preferably the vendor also), so that the buyer is informed that a presented invoice will be paid on the set payment initiation date. Should the buyer determine that the payment is somehow unusual or problematic, the buyer has the capacity before the payment initiation date to withdraw the invoice from automatic payment, and thus cancel the payment initiation date. The onus, however, is on the buyer to prevent payment under such circumstances, or the payment will proceed as set. In such circumstance, any invoice withdrawn from automatic payment may then be subject to the conventional buyer approval process. The automatic payment system, therefore, is configured to receive a command signal from the buyer to withdraw the invoice from automatic payment. If such a command signal is received by the automatic payment system prior to the set payment initiation date, the payment system may cancel the automatic payment initiation date for the invoice until such time as an is received from the buyer.

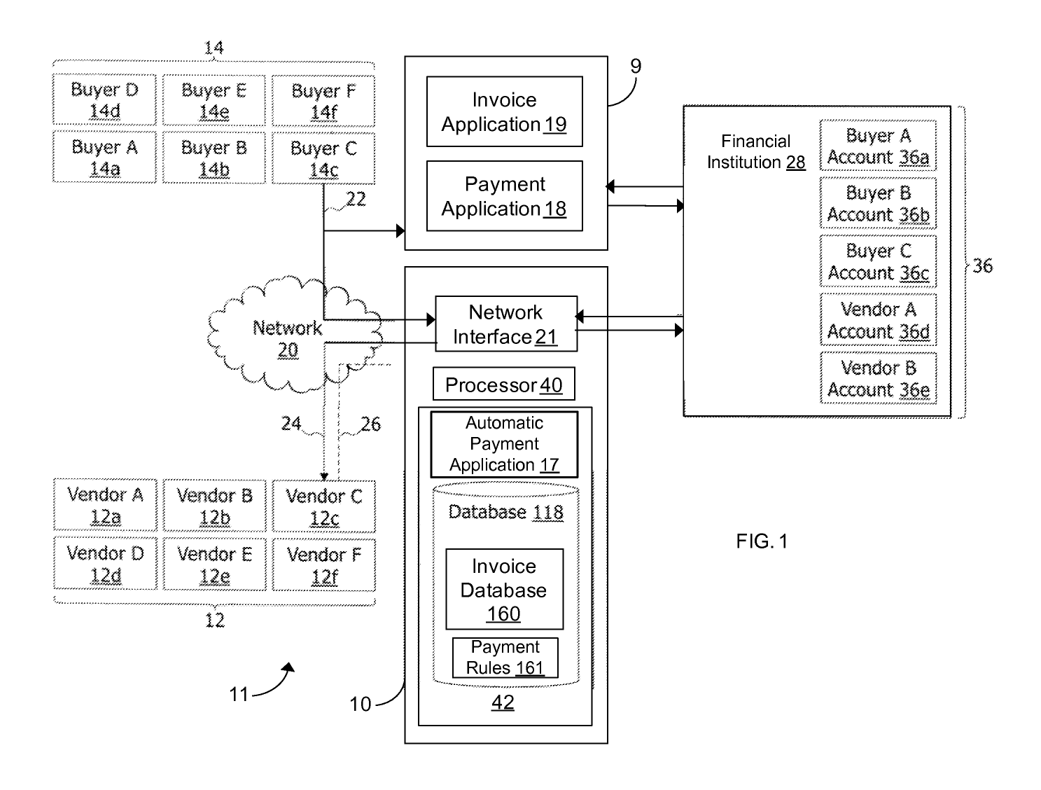

FIG. 1 depicts an exemplary architecture 11 for electronic invoicing, including an electronic invoicing and payment system 9 that operates in conjunction with an automatic payment system 10. The exemplary electronic invoicing and payment system 9 may include a payment application 18 and an invoice application 19, each of which may be instructions coded and stored on a non-transitory computer readable medium and executed by a processing device. The electronic invoicing and payment system 9 (sometimes referred to herein in short form as invoice payment system 9) provides for on-line invoice presentment that includes modules for reporting invoice approval and payment status to the vendors 12. In general, the invoice application 19 electronically delivers invoices initiated by a vendor 12, and thereby presents the invoice to the applicable buyer 14. The invoice application 9 also includes a reporting function that provides vendors connected to the automatic payment system 10 with invoice status information. For example, a vendor may present an invoice to a buyer via the invoicing application. The invoice may then be automatically entered into an accounts receivable system of the buyer. In one example, the status of the invoice may be updated to “received” such that the vendor may view the status of the invoice to verify that the invoice has been received by the buyer.

At this point, as further explained below, the invoice may be subjected to an analysis by the automatic payment system 10, which determines whether to subject the invoice to automatic payment. If the invoice is subjected to automatic payment, the invoice is automatically approved and the payment initiation date is set. If the invoice is not determined to be subject to automatic payment, the invoice instead may be subjected to the buyer's conventional approval process. Whether the invoice is approved automatically by the automatic payment system or by the buyer's conventional approval process, the status of the invoice may be updated again to indicate approval for payment, which the vendor may view. Upon approving the invoice for payment, the invoice payment system 9 may execute payment from the buyer's financial account, such as a bank or credit account, to the vendor. For this purpose, the invoice payment system 9 and automatic payment system 10 may be communicatively coupled to a financial institution in which the buyer has an account or credit line, such as the financial institution 28 in FIG. 1.

In exemplary embodiments, the electronic invoicing and payment system 9 and related invoice payment system 10 would be operated by a third party invoice processing entity. The third party invoice processing entity may be a service provider that processes invoices for multiple participating vendors as part of a fee based service. In such a system, each presented invoice would be associated with a buyer for payment, and in turn made accessible to the associated buyer as part of the invoice processing. Accordingly, multiple invoices from various vendors may be associated with various buyers. The number and types of vendors and buyers participating in the electronic invoice and payment system operated by the third party service provider may vary extensively.

Such an exemplary electronic invoicing and payment system is further described in U.S. patent application Ser. No. 13/068,558 filed on May 13, 2011, the entire contents of which are incorporated by reference herein. Other exemplary invoice and payment systems include systems that utilize the automated clearing house (ACH) payment system, wire transfers, electronic check and bank transfers, and other electronic fund transfer (EFT) systems that may be part of card payment networks, such as networks operated by Visa, MasterCard, and American Express, and the like.

Referring again to FIG. 1, as referenced above the electronic invoicing and payment system 9 may operate in conjunction with an automatic payment system 10. The automatic payment system 10 may be a computer system including one or more servers including at least a processor 40, a network interface 21, and a computer readable medium 42. The computer readable medium 42 may be a non-transitory computer readable medium that includes encoded thereon an automatic payment application 17 and a database 118. The automatic payment application 17 may be a computer program comprising instructions embodied on the computer readable medium 42 and executed by the processor 40. The database 118 may include data structures, also referred to as tables, as described herein and may include instructions embodied on computer readable medium 42 for interfacing with the network interface 21 and the automatic payment application 17 for reading and writing data to the data structures and tables.

The network interface 21 may be communicatively coupled to each buyer 14a-14f of a community of multiple buyers 14, and to each vendor 12a-12f of a community of multiple vendors 12 via a network 20. It will be appreciated that the specific number and nature of the vendors 12 and buyers 14 may vary substantially. The network 20 may be an open network, such as the Internet, a private network, such as a virtual private network, or any other suitable network. The network interface 21 may receive invoices and invoice updates from the vendors 12 and/or buyers 14. For example, the network interface 21 may be configured to enable, for a given invoice, updating of the status of at least one event associated with approval and payment of the given invoice based on a received invoice update. The network interface 21 may include a wireless network adaptor, an Ethernet network card, or any suitable device that provides an interface between the automatic payment system 10 and the network 20.

The invoices and invoice updates received by the network interface 21 may be stored in an invoice database 160 contained in the database 118. The invoices may be stored in the invoice database 160 as records. Each record corresponds to an invoice and may identify an associated vendor, an associated buyer, and contain status information. The invoice database may store records corresponding to different combinations of associated multiple vendors and buyers. The status information may correspond to activity of the associated buyer and/or vendor in relation to a given invoice and may include any combination of a current status, a current status update timestamp indicating the date when the invoice status was last updated, a list of past statuses, and, for each of the past statuses in the list of past statuses, a past status timestamp indicating the date when the past status was updated.

The records stored in the invoice database 160 may correspond to invoices for which payment has been received (“paid invoices”) and/or invoices for which payment has not been initiated (“unpaid invoices”). The invoice status updates received by the network interface 21 may be used to update the status of invoices stored in the invoice database 160. For example, the invoice updates may include a status update that payment for a given invoice was initiated. Under such circumstances, the status of an invoice may be altered from “unpaid invoice” to “payment initiated” invoice. Upon final settlement of the payment transaction, the status of an invoice may then be updated again to “payment received”. The timestamp associated with the various statuses are updated commensurately with the status updates to indicate, for example, when payment was initiated and when payment has been received (i.e., settled).

As will be understood by those of ordinary skill in the art, the database 118 may describe a data structure which embodies groups of records or data elements stored in a volatile or non volatile storage media and accessed by an application, which may be instructions coded to a storage medium and executed by a processor. The database may include multiple individual databases stored on the same storage medium or on multiple different storage media. The automatic payment system 10 may also store data in and access the database. While the database 118 is depicted as a component of the automatic payment system 10 in FIG. 1, the database 118 could alternatively be stored on a separate server or locally, for example, on a buyer's computer and/or on a vendor's computer.

The processor 40 may constitute an electronic controller that is configured to carry out overall control of the functions and operations of the automatic payment system 10. The processor 40 may include a processing device such as a CPU, microcontroller or microprocessor. To implement the features of the present invention, the processor may be configured to execute program code embodied as the automatic payment application 17. It will be apparent to a person having ordinary skill in the art of computer programming of electronic devices and servers how to program the components of the automatic payment system to operate and carry out logical functions associated with the automatic payment application 17. Accordingly, details as to specific programming code have been left out for the sake of brevity. Also, controller functionality could be carried out via dedicated hardware, firmware, software, or any combinations thereof, without departing from the scope of the invention. As will be understood by one of ordinary skill in the art, therefore, the processor 40 may have various implementations. For example, the processor 40 may include any suitable device, such as a programmable circuit, integrated circuit, memory and I/O circuits, an application specific integrated circuit, microcontroller, complex programmable logic device, other programmable circuits, or the like. The processor 40 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor.

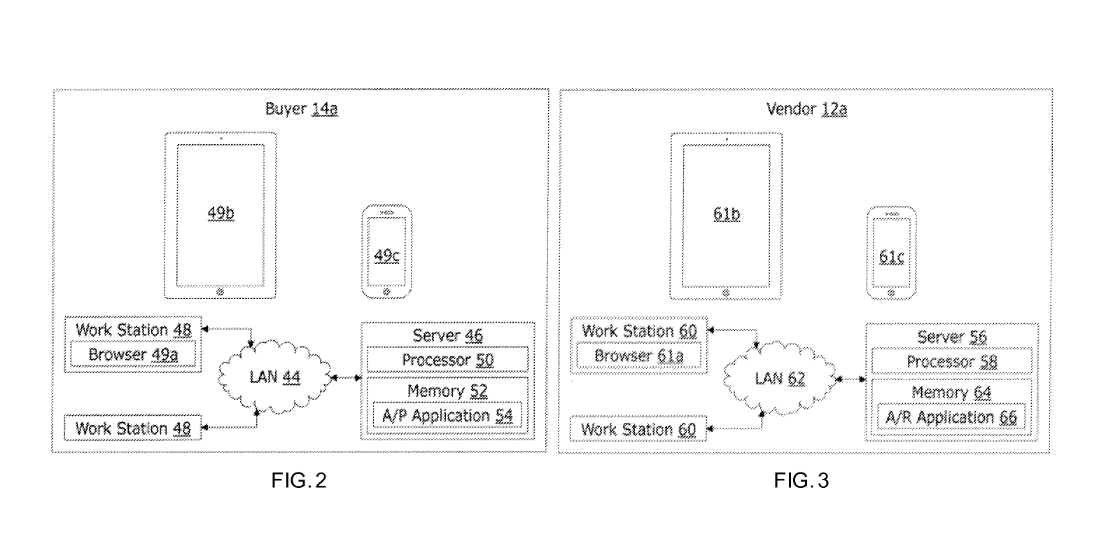

Referring to FIG. 2 in conjunction with FIG. 1, in an exemplary embodiment, each buyer, such as buyer 14a for example, may be a business that includes at least one computer system or server 46. The computer system(s) or server(s) 46 may include at least one processor 50 and associated computer readable medium 52 programmed with an accounts payable application 54. In a typical environment, the computer system(s) or server(s) 46 operating the accounts payable application 54 may be coupled to a local area network (LAN) 44 and accessed by entitled users of workstations 48 and may be used for managing the buyer's accounts payables and issuing payments to its vendors. Each buyer, again using buyer 14a as an example, may further include one or more access systems for interfacing with the payment acceleration system 10. Exemplary access systems include: i) a web browser 49a on a workstation 48 or other computer which accesses system 10 via a web connection; ii) a tablet computer 49b such as an iPad or Windows Surface which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

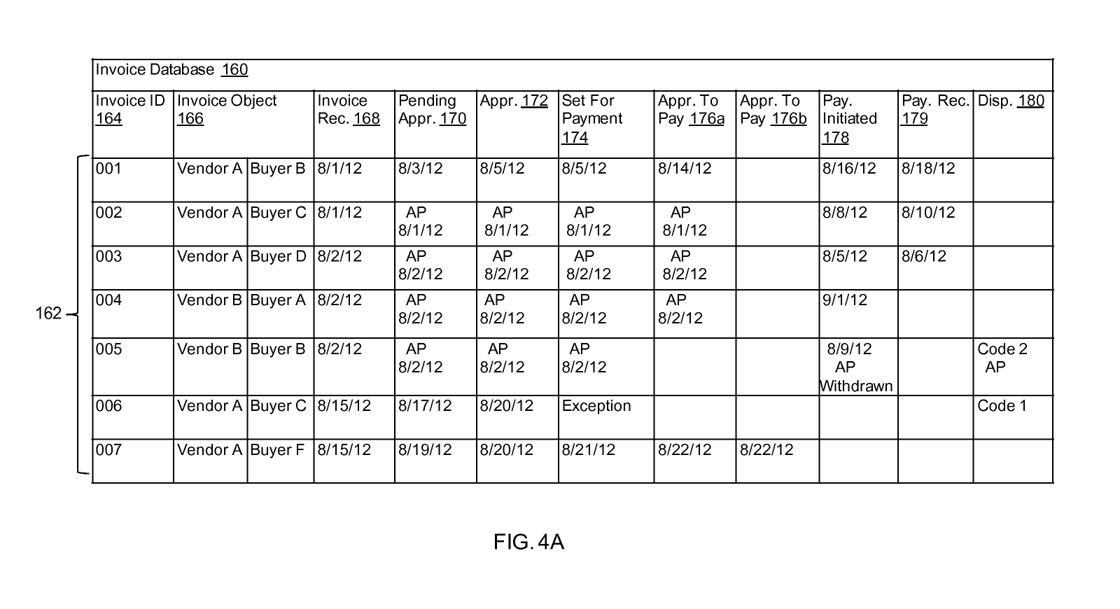

Referring to FIG. 3 in conjunction with FIG. 1, in an exemplary embodiment, each vendor, such as vendor 12a for example, may be a business that includes at least one computer system or server 56. The computer system(s) or server(s) 56 may include at least one processor 58 and associated computer readable medium 64 programmed with an accounts receivable application 66. In a typical environment, the computer system(s) or server(s) 56 operating the accounts receivable application 66 may be coupled to a local area network (LAN) 62 and accessed by entitled users of workstations 60 and may be used for issuing invoices and managing the vendor's accounts receivables and reconciling payments issued by customers (i.e. buyers) against amounts due to the vendor. Each vendor, again using vendor 12a as an example, may further include one or more access systems for interfacing with the system 10. Similarly as to the buyers, exemplary vendor access systems include: i) a web browser 61a on a workstation 60 or other computer which accesses system 10 via a web connection; ii) a tablet computer 61b such as an iPad or Windows Surface which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

Returning to FIG. 1, for purposes of illustrating the invention, a participating financial institution 28 is depicted. The financial institution 28 may be a bank or like institution that can hold accounts of the vendor and buyers and process payment transactions. The financial institution 28 may include a payment system (i.e. instructions coded to a computer readable medium and executed by a processor) which may manage customer deposit accounts 36 for at least a portion buyers 14 and/or a portion of the vendors 12, including execution of credit and debit transactions to specific deposit accounts 36a-36e in a traditional manner.

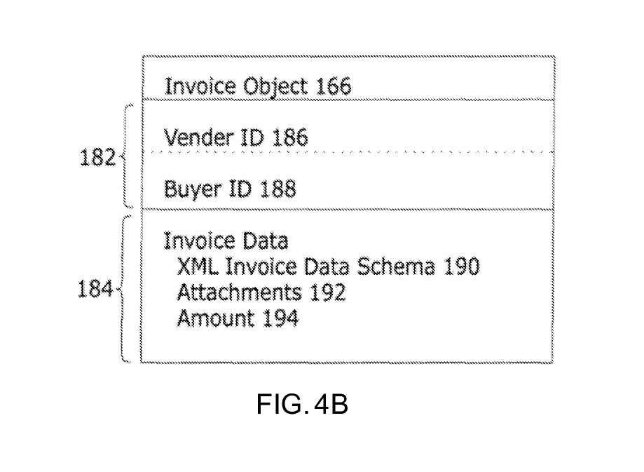

Referring to FIG. 4A in conjunction with FIG. 1, the database 118 may further include, as one of the data structures, the invoice database 160 as referenced previously. The invoice database 160 may include a plurality of records 162, with each record 162 corresponding to an invoice. Each invoice record 162 associates a unique invoice ID 164 with a unique invoice object 166 and a group of exemplary status fields. In the exemplary embodiment of FIG. 4A, the status fields may include an invoice received status field 168, a pending invoice approval status field 170, an invoice approved status field 172, a set for payment status field 174, a first approved to pay status field 176a, a second approved to pay status field 176b, a payment initiated status field 178, a payment received field 179, and a disputed invoice status field 180. As stated previously, the invoice status is not limited to the above listed statuses. For example, the invoice statuses may fall under one of three global statuses (e.g., in process, rejected for processing, ready for payment). As another example, the invoice statuses may include default statuses and/or user defined statuses.

Each status field represents a completed step within a group of processing steps the buyer performs to approve and pay the invoice, whether within the invoice application 19 itself or within the buyer's accounts payable system 43 (FIG. 2) (or both) represented by the record 162. For example, the invoice received status field 168 may represent an initial step at which the buyer has completed receipt of a presented invoice into his accounts payable system. Additionally, the pending approval status field 170 may represent steps following receipt of the invoice which are performed by the buyer prior to formal approval of the invoice.

The approved status field 172 may represent an initial formal approval of the invoice, which essentially completes the receiving process of the buyer. The buyer would then subject the invoice to an analysis and approval of payment of the invoice. In particular, the set for payment status field 174 may represent a step of setting the payment of the invoice. The first approved to pay status field 176a may represent a first approval of the payment. The second approved to pay status field 176b may be an optional step representing a second level approval of the payment. The optional step 176b may apply based on the buyer's approval rules, for example, high value payments may require a second level of approval. The payment initiated status field 178 may represent the buyer initiating the payment such as by issuing a payment order. The payment received status field 179 may represent the vendor's receipt of the payment. The disputed status field 180 may represent the buyer disputing all or a portion of the invoice.

Each status field may operate as a status flag for that processing step in that whether the value is populated, or whether a particular value is populated, indicates whether the buyer has completed the processing step. In the exemplary embodiment, each of the status fields may be populated with the status timestamp (i.e., the date and time that the process was completed).

Referring to FIG. 4B, an exemplary invoice object 166 may include a header 182 and a body 184. The header 182 may include a vendor ID 186 and a buyer ID 188 identifying the vendor issuing the invoice and the buyer to which the invoice is delivered. The body 184 of the invoice object includes invoice data. The invoice data may include data components of a standardized XML data schema 190, which may be an invoice data scheme standardized by the ISO 20022 standard. The invoice data may also include attachments 192, which would typically be PDF files but could be attachments in other file formats, which provide more detailed information about invoice line items. The invoice object 166 also may include an amount field 194 indicating the amount of the invoice.

Referring again to FIG. 4A, the automatic payment system of the present invention affects the various status fields and the associated stored data. As referenced above, the automatic payment system determines whether an invoice satisfies one or more rules for triggering the automatic payment. Invoices that become subject to the automatic payment system become indicated as such in the records 162 of the invoice database 160.

In the example depicted in FIG. 4A, within the records 162 of the invoice database 160 are invoice objects 166 as depicted in FIG. 4B, such as at least a first invoice object (Invoice ID 001 for example) which includes identification of a first vendor (Vendor A for example) and additional invoice objects (Invoice ID 002-007 for example), which also include identification of the corresponding vendor (Vendor A or Vendor B for example depending on the invoice). Each vendor is a distinct organization with responsibility for presenting and collecting on its own invoices. Also within the records 162 of the invoice database 160 are the identification of each buyer that is associated with a respective invoice. For example, the first invoice object (Invoice ID 001 for example) includes identification of a first associated buyer (Buyer B for example). Each additional invoice object (Invoice ID 002-007 in this example) also includes identification of the corresponding associated Buyer (Buyers A, C-F for example depending on the invoice). Each buyer is a distinct organization with responsibility for payment of invoices distinct from other buyers. In this manner, vendor invoices are associated with respective buyers via the invoice objects 166.

In the example of FIG. 4A, the first invoice may be considered as exemplifying a conventional invoice approval process of a buyer. For example, the record 162 with an invoice ID 001 may include an invoice 166 issued by Vendor A to Buyer B. For purposes of the example of FIG. 4A, it is assumed that all processes have been completed and a date is populated to each field. The Invoice 001 record indicates that the invoice was presented to the buyer on 8/1/12 (field 168) with a following demand for payment on 8/5/12 (field 174). In this conventional example, the invoice then became subject to the buyer's internal approval process. The record indicates that Invoice 001 was not approved for payment until 8/14/12 (field 176a), and payment was not actually initiated for another two days (field 178). Payment was received finally on 8/18/12. Accordingly, in this typical example, there is a seventeen day delay from when the invoice is first presented by the vendor until the actual payment is received, with the bulk of the delay being caused by the buyer's own internal approval and payment process. A second level approval step 176b is not required in the example of Invoice 001, but it will be appreciated that the more involved the buyer's approval process would be, the greater the delay.

Invoices IDs 002-005 illustrate variations of examples of invoices that are subject to the automatic payment system of the present invention. The record 162 with an Invoice ID 002 includes an invoice 166 issued by Vendor A to Buyer C. The designation “AP” in the record 162 generally is indicative that the corresponding invoice is subject to an “Auto-Pay” automatic payment system. In the exemplary implementation, therefore, the automatic payment system is referred to in the simpler vernacular as the Auto-Pay system or feature.

As such, in the Auto-Pay system the payment presentment date (field 168) drives the payment process. In this manner, all steps through the buyer approval (through fields 176a and optionally 176b) are performed automatically by the automatic payment system 10 of FIG. 1, and thus occur essentially simultaneously with (or at least on the same day as) the invoice presentment on 8/1/12. The automatic payment system then automatically sets the payment initiation date to 8/8/12 (field 178) in this example, or one week after presentment. Importantly, the payment initiation date is set automatically under the rules applicable to that invoice, without the need for the invoice to proceed through the conventional buyer approval process as performed as to Invoice 001.

Although in the example of Invoice 002 payment initiation was set for seven days after presentment, longer or shorter presentment-to-payment payment initiation periods may be employed depending on the rules set for a particular invoice. For example, the record 162 with an Invoice ID 003 may include an invoice 166 issued by Vendor A to Buyer D. Again, this payment is subject to the Auto-Pay system as indicated by the “AP” designation, and thus the payment presentment date (field 168) drives the payment process. All steps through the buyer approval (through fields 176a and optionally 176b) are performed automatically, and thus occur essentially simultaneously with (or at least on the same day as) the invoice presentment on 8/2/12. For Invoice 003, the payment initiation date is set to 8/5/12 (field 178), or only three days after invoice presentment (field 178). Invoice 003 may be a simple transaction, such as recurring transaction or a small amount transaction for example, that typically should not require any significant substantive review. As above for Invoice 002, the payment initiation date is set automatically under the rules applicable to that invoice relative to the buyer, without the need for the invoice to proceed through the conventional buyer approval process.

As another example, the record 162 with an Invoice ID 004 may include an invoice 166 issued by Vendor B to Buyer A. Again, this payment is subject to the Auto-Pay system as indicated by the “AP” designation, and thus the payment presentment date (field 168) drives the payment process. All steps through the buyer approval (through fields 176a and optionally 176b) are performed automatically, and thus occur essentially simultaneously with (or at least on the same day as) the invoice presentment on 8/2/12. For Invoice 004, the payment initiation date is set to 9/1/12 (field 178), or thirty days after presentment (field 178). Invoice 004 may be a more complex or rarer transaction, or Buyer A simply may have more favorable payment terms permitting such thirty day payment window. Regardless, the vendor still benefits from the advantage that payment initiation is set automatically, giving the vendor increased certainty as to the expectation and timing of payment. In the example of Invoice 004, it is assumed that the payment initiation date has not arrived, and thus there is as yet no entry for the date the payment is received. Invoice 004, therefore, illustrates the feature of the Auto-Pay system that the payment initiation dates are not only set automatically, but also set in advance of the actual arrival of the payment initiation date. In this manner, as referenced above, a vendor is afforded increased certainty as to when the payment is to be initiated and processed.

The example of Invoice 005 illustrates an additional feature of the Auto-Pay system pertaining to buyer action on the presented invoice. The record 162 with an Invoice ID 005 may include an invoice 166 issued by Vendor B to Buyer B. This invoice, at least initially, also has been subjected to the automatic payment system as indicated by the “AP” designations. As such, the invoice has been presented and a demand for payment has been made automatically (fields 170,172, 174). Payment initiation also had been set automatically for 8/9/12, seven days after invoice presentment. In this example, however, the payment approval fields (both 176a and 176b) are blank, and the payment initiation field 178 indicates that the payment initiation has been “AP Withdrawn”. An additional entry of an Auto-Pay “Code 2 AP” appears in the dispute field 180. In this example, therefore, the buyer has determined that Invoice 005 should not be subjected to the automatic payment process. For example, the buyer may have noticed an usual aspect or problem with the invoice, or otherwise has determined that the invoice falls within some exemption to the rules for automatic payment processing. Invoice 005, having been withdrawn from the automatic payment system, would now go through the conventional buyer approval process similarly as had been applied to Invoice 001. In this manner, buyers can be protected from an inappropriate application of the automatic payment process, although vendors still benefit in that the onus falls on the buyer to withdraw an invoice from automatic payment processing or the invoice will proceed to automatic payment initiation.

The remaining invoices records, Invoices 006 and 007, may illustrate additional application of the more conventional approval process. For Invoices 006 and 007, therefore, the system has determined that such invoices do not satisfy the rules for triggering automatic payment processing. The record 162 with an invoice ID 006 may include an invoice 166 issued by Vendor A to Buyer C. As to Invoice 006, Buyer C has performed only the first three sequential processing steps (invoice received 168, pending approval 170, and pending approval 172). The record 162 with an invoice ID 007 may include an invoice 166 issued by Vendor A to Buyer F. As to Invoice 007, a second level approval step 176b is required, and Buyer F has performed all of the sequentially processing steps prior to the payment initiated step 178.

It is envisioned that the automatic invoice payment system 10 would be operated by a third party invoice processing entity. The third party processing entity may be a service provider that processes invoices for multiple participating vendors as part of a fee based service. The automatic payment system 10, therefore, is configured, such as via the network interface, to receive invoices that are presented from multiple vendors for payment by multiple buyers. The various invoices would be entered into the invoice database 160 as the records 162 described above. In such a system, each presented invoice would be associated with a buyer for payment, and in turn made accessible to the associated buyer as part of the invoice processing. In exemplary embodiments, multiple invoices from various vendors may be associated with a common buyer, and such multiple invoices may be made accessible to the common buyer in a consolidated file for more efficient notice and processing. The buyer can access the invoice information from the third party provider system. In this manner, when a buyer logs into the system to access invoice records, multiple invoices associated with the buyer readily may be accessed for payment processing based on a consolidated file format.

As referenced above, a deficiency of conventional invoice payment systems for vendors is that vendors typically lack control over the manner of payment approval and processing by the buyer. A buyer's internal approval processing can result in significant delays between invoice presentment and payment initiation, which can result in decreased value to the vendor. The buyer's internal approval processing can also cause uncertainty to the vendor as to when the actual payment will be processed. The present invention overcomes such deficiencies by providing a system and methods that provide for automatic payment without the need for subjecting the invoice to the conventional buyer approval processing. The automatic payment system of the present invention analyzes a given invoice to determine whether the invoice satisfies one more rules for automatic payment processing, and when an invoice satisfies such one or more rules, automatic payment processing is applied. For such invoices, delays resulting from the buyer's internal approval processing are avoided, and vendors have increased certainty as to when payments will be initiated and processed.

An aspect of the invention, therefore, is an automatic invoice payment system, such as the automatic payment system 10. Exemplary embodiments of the automatic invoice payment system include a database stored on a non-transitory computer readable medium, the database including a plurality of records, each record corresponding to an invoice issued by a vendor for payment from a buyer. A network interface is configured to receive presented invoices from multiple vendors for payment by multiple buyers, wherein the presented invoices are stored in the database. A processor is configured to associate each invoice that is presented from a vendor with a buyer for payment, and to provide electronic access to one or more of the invoices by an associated buyer. The processor further is configured to analyze each invoice that has been presented to determine whether the presented invoice satisfies one or more predetermined rules, and when the processor determines that the presented invoice satisfies the one or more predetermined rules, to automatically set a payment initiation date upon which payment of the presented invoice is to be automatically initiated. The processor may be configured to perform such operations by the execution of an automatic payment application, such as automatic payment application 17 stored on the non-transitory computer readable medium 42.

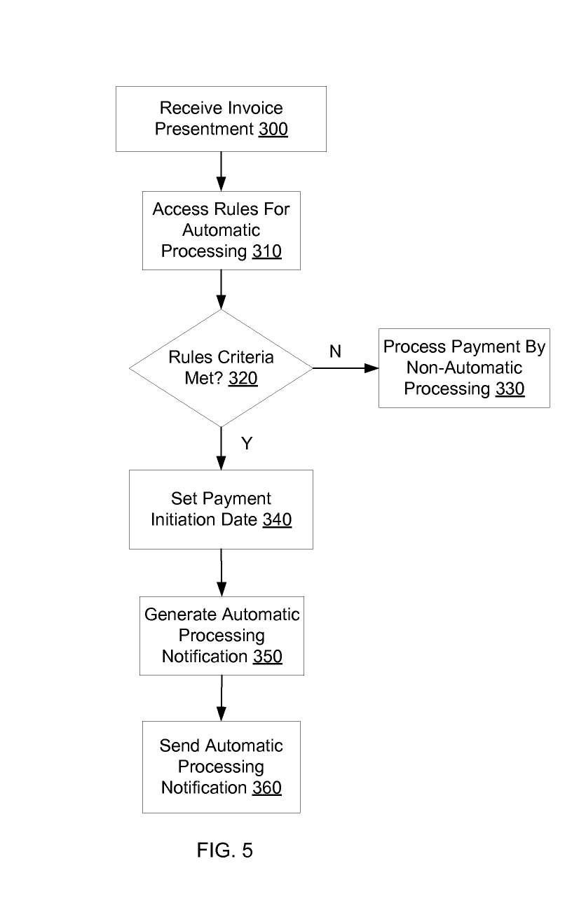

As illustrative of the operation of such an automatic payment system 10, FIG. 5 is a flow chart diagram depicting an overview of an exemplary method of automatically processing invoice payments in an invoice transaction system. In exemplary embodiments, the automatic payment system 10 of FIG. 1 is configured to execute the described method, such as by the processor 40 executing code embodied as the automatic payment application 17 stored on the non-transitory computer readable medium 42. Accordingly, in demonstrating the method, reference also is made to the invoice payment system as depicted in FIG. 1, which includes the automatic payment system 10. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 300, at which an invoice presentment is received by the automatic payment system from a vendor. Referring to the architecture of FIG. 1, the invoice presentment and date thereof may entered into the invoice database 160 stored in the database 118 as described above. A vendor 12 may enter an invoice presentment input at a vendor workstation (see, e.g., FIG. 3) as to any invoice issued by the vendor 12 for which payment is coming due from a buyer 14. The automatic payment system 10 may receive the inputted invoice presentment data and information via the network interface 21 over the network 20. The system associates each presented invoice with a buyer, such as, for example, by extracting the buyer identify from the invoice information. The invoice may then be transmitted to the associated buyer to provide the buyer notice of the invoice. Additionally or alternatively, the system made provide the buyer electronic access to invoice information, such by providing a buyer login identity for access. When a buyer is associated with multiple invoices, access may be provided upon login to invoice information for invoices from multiple vendors contained in a consolidated electronic file format.

At step 310, the automatic payment system 10 accesses rules for determining whether or not the presented invoice should be subjected to automatic payment processing. The rules may be stored in a database, such as a rules database 161 that also is part of the database 118 stored on the non-transitory computer readable medium 42. It will be appreciated that the precise configuration of the databases may be varied. For example, the database 161, although being depicted as part of the database 118, may be a separate database, and may be stored remotely from the automatic payment system 10. The automatic payment system 10 may receive any rules criteria and definitions that have been inputted by the buyer at a buyer workstation (see, e.g., FIG. 2). Additionally or alternatively, the automatic payment system 10 may receive any rules criteria and definitions that have been inputted by the vendor at a vendor workstation (see, e.g., FIG. 3). The rules inputs may be received by the automatic payment system 10 via the network interface 21, and such criteria may be stored as part of the database 118 for use in the analysis by the processor 40.

The rules may be based on various procedures, processes, and/or circumstances pertaining to the invoice as relative to the buyer. The rules may be set by either the buyer or vendor in whole or in part, or by the combination of buyer and vendor as part of the agreed transaction terms as between the buyer and vendor. Examples of rules are as follows.

Historical performance data associated with invoices comparable to the presented invoice, based on predefined criteria, may provide one basis for applying automatic payment processing to the presented invoice. The predefined criteria for considering invoices comparable to the presented invoice may include criteria associated with the presented invoice being repetitive as compared to the comparable invoices. Repetitive invoices, and thus comparable invoices, typically would be invoices issued by a common vendor to a common buyer for a like service or product, with the repetitive invoices being issued by a vendor based on a set periodic time period (a monthly service fee for example).

For example, the presented invoice may be a repetitive invoice for a like product or service presented at a time based on a preset periodic time period as to which the comparable invoices were presented. Automatic payment processing thus may be applied to invoices that qualify as repetitive payments in which comparable invoices are paid based on the preset periodic time period (e.g. invoices that are comparably repeated monthly, quarterly, or the like). An exemplary rule, therefore, may be to subject all such repetitive periodic invoices to automatic payment processing. A modification of such a rule may be a determination as to whether a presented invoice is within an acceptable variation or tolerance in view of historical performance and/or an expected payment amount as compared to previous comparable invoices for the like service or product. More specifically, automatic payment processing would be applied to a repetitive invoice that falls within a variance range of a threshold amount that is set in view of historical data and/or expected payment amounts in comparable invoices. A typical example may be to apply automatic payment processing to a qualifying repetitive invoice that is in an amount of $500.00±$50.00, but generally any applicable variation or tolerance may be any suitable range in the form of a threshold amount±a variance range.

Furthermore, although such an amount range is described above in relation to repetitive comparable invoices, such an amount range alternatively may be applied as a singular rule. For example, automatic processing may be applied to any presented invoice (and not just repetitive type invoices) that fall within a variation or tolerance of a threshold amount±a variance range. As another rule variation, automatic payment processing may be applied using an invoice amount as a more absolute threshold. For example, automatic payment processing may be applied to any presented invoice that satisfies a set threshold amount, such as a presented invoice that is less than, or alternatively greater than, a fixed threshold amount. Any suitable threshold amount may be employed. It further will be appreciated that any threshold and/or variance range amounts need not be the same for all categories of invoices. Such amounts, for example, may vary depending on the nature of the product or service associated with the invoice, or based on the buyer identity.

The rules need not be tied to invoice amounts. Another example rule may be to apply automatic processing to invoices that pertain to at least one of an approved product(s) or service(s). Such product(s) or service(s) may be identified in the invoice records by a corresponding product/service number and/or product/service description. Relatedly, automatic invoice processing may be applied to invoices that pertain to a quantity of an approved product or service within a prescribed amount. Examples may be to apply automatic processing to invoices within a set percentage of a desired threshold quantity (e.g., 95% of estimated quantity of items), or based on a threshold number of items±a variance range (e.g., 100 units±10).

Other example rules may be based on invoice timing. For example, another rule may be to apply automatic processing to invoices that are presented within a specified number of “X” days (any suitable number of days may be designated) of the delivery of the product or service. Such a rule may be useful to prevent back billings.

Other rules may include whether the presented invoice satisfies one or more criteria that operate to validate or verify the invoice. For example, the automatic payment system may be configured to validate the accuracy of any invoice calculations pertaining to the presented invoice, such as sums and amounts, and the like. Similarly, the automatic payment system may verify that the presented invoice matches a particular corresponding purchase order, verify that the presented invoice is not a duplicate, or otherwise verify that the presented invoice is valid and accurate. Accordingly, another example rule may be to apply automatic processing to invoices that satisfy one or more of such validation criteria.

It will be appreciated that the various rules described above are but examples. Any suitable criteria may be employed for triggering automatic payment processing. In addition, rules may be applied singularly or in any combination of multiple criteria, including combining one or more rules types (e.g., amount based, time based, product based, validation based, etc.)

Referring again to FIG. 5, as referenced above, at step 310, the automatic payment system 10 accesses the rules for determining whether or not the presented invoice should be subjected to automatic payment processing. At step 320, the automatic payment system 10 analyzes the invoice and determines whether or not the presented invoice satisfies one or more of the rules. The automatic payment system may analyze the invoice as part of the processor 40 executing the automatic payment application 17.

If at step 320 the automatic payment system renders a “No” determination, indicating that the invoice does not meet the one or more rules, the method proceeds to step 330 at which the payment is processed in accordance with non-automatic processing. For example, such processing may includes the need for the buyer to approve the invoice and manually initiate payment as described above with respect to conventional payment systems. In such case, there being no basis to apply automatic processing based on the rules, the payment would be processed in accordance with conventional non-automatic processing, which typically would invoke application of the buyer's conventional internal approval and payment processes.

If at step 320, however, the automatic payment system renders a “Yes” determination, indicating that the invoice does in fact satisfy one or more rules for automatic processing, the method proceeds to step 340 to process the payment automatically. As part of the automatic processing, at step 340, the automatic payment system 10 automatically sets a payment initiation date. The payment initiation date may be based on the nature of the invoice and any payment terms that have been set as between the vendor and the buyer. Once the payment initiation date arrives, the payment will be executed automatically. For example, the processor 40 of the automatic payment system 10 may generate a processing signal and transmit such signal via the network interface 21 to the electronic invoicing and payment system 9, which would execute the payment with the payment application 19 in accordance with the set payment initiation date.

At step 350, a notification is generated to be sent to at least the buyer, and preferably both the vendor and buyer. For example, the processor 40 of the automatic payment system 10 may generate the notification by extracting buyer information from the presented invoice, particularly from the corresponding invoice record 162. The extracted buyer information may include such features as the buyer identity and a buyer correspondence address for invoice payment, which preferably is an electronic mailing address. In this manner, notifications to the buyer are provided automatically and electronically for most efficient processing.

The notification would provide notice to the buyer and vendor that the invoice has been presented, has been subjected to automatic processing and approved, and that payment is scheduled on the set payment initiation date. For example, the processor 40 of the automatic payment system 10 may be configured to generate such notification and transmit the notification to the buyer or vendor workstations. At step 360, the notification is sent to the buyer and vendor. The notification may be transmitted via the network interface 21 to the buyers and vendors via the network 20. It also will be appreciated that a buyer or vendor may not always be at a corresponding workstation when a notification is generated, and the notifications have substantial time sensitivity. Accordingly, notifications may be transmitted to various electronic devices, and particularly mobile devices (e.g., laptop computers, tablets and tablet computers, smart phones, etc.), so that buyers and vendors can receive the notifications by numerous means.

As referenced above, an additional feature of the automatic payment system 10 may be to afford the buyer the opportunity to withdrawn the payment from automatic payment processing prior to the payment initiation date. For example, the buyer may have noticed an usual aspect or problem with the invoice, or otherwise has determined that the invoice falls within some exemption to the rules for automatic payment processing. In this manner, even if a payment initially is determined by the system to be subject to automatic processing, the buyer has the capability to halt the automatic processing and thereafter process the invoice in accordance with conventional non-automatic processing. In this manner, buyers can be protected from an inappropriate application of the automatic payment process, although vendors still benefit in that the onus falls on the buyer to withdraw an invoice from automatic payment processing or the invoice will proceed to automatic payment initiation.

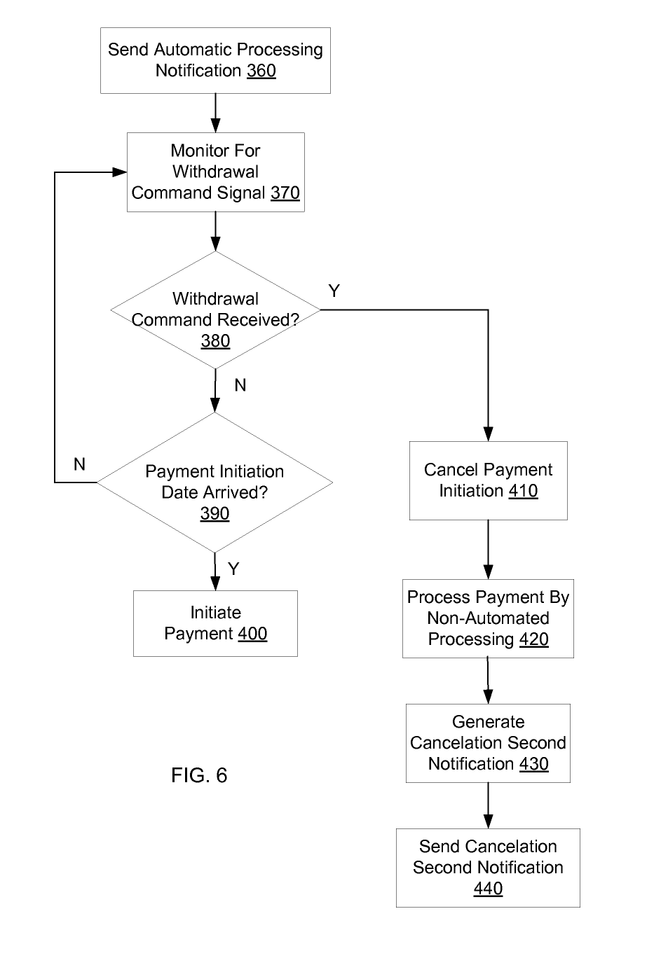

FIG. 6 is a flow chart diagram depicting an overview of a modified exemplary method of automatically processing invoice payments in an invoice transaction system, with the additional features of a buyer intervention process. Steps 300-360 of FIG. 5 would be performed as the initial steps of the method of FIG. 6. For convenience of illustration, therefore, the depiction in FIG. 6 begins with the notification step 360 as the initial step, but it will be appreciated that steps 300-350 already would have been performed by the system. As with the method of FIG. 5, in exemplary embodiments of executing the additional features constituting the method of FIG. 6, the automatic payment system 10 of FIG. 1 is configured to execute the described method, such as by the processor 40 executing code embodied as the automatic payment application 17 stored on the non-transitory computer readable medium 42. Accordingly, in demonstrating the method, reference also is made to the invoice payment system as depicted in FIG. 1, which includes the automatic payment system 10. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Following the notification at step 360 as described above, the method proceeds to step 370 at which the automatic payment system 10 monitors for receipt of a withdrawal command signal from a buyer. If the buyer determines that the invoice should not be subjected to automatic payment processing, the buyer may enter a withdrawal command at a buyer workstation, or any other device, such as a mobile device, that may receive the notification and provide an interface for entering input commands (e.g., laptop computers, tablets and tablet computers, smart phones, etc.). A withdrawal command may be transmitted from a suitable buyer device over the network 20, and received by the automatic payment 10 over the network interface 21.

The method then proceeds to step 380, at which the automatic payment system 10 determines whether in fact a withdrawal command signal is received. If at step 380 the automatic payment system renders a “No” determination, indicating that a withdrawal command has not been received, the system then proceeds to step 390 to check for whether the payment initiation date has arrived. If at step 390 the automatic payment system renders a “No” determination, indicating that the payment initiation date has not yet arrived, the method of FIG. 6 loops back to step 370 to continuously monitor for receipt of a withdrawal command signal from the buyer. In other words, the automatic payment system 10 will continuously monitor for receipt of a withdrawal command up until the set payment initiation date has been reached.

Once the automatic payment system 10 renders a “Yes” determination at step 390, the payment initiation date has arrived without there ever having been received a withdrawal command signal from the buyer. In such case, the method proceeds to step 400 and payment is initiated in accordance with the payment initiation date that has been set automatically by the system. For example, the processor 40 of the automatic payment system 10 may generate a processing signal and transmit such signal to the electronic invoicing and payment system 9, which would execute the payment with the payment application 19 in accordance with the set payment initiation date.

Referring back to step 380, when at step 380 the automatic payment system renders a “Yes” determination, a withdrawal command in fact has been received from the buyer. In such case, the method proceeds to step 410, at which the automatic payment system 10 cancels the payment initiation date. The method then proceeds to step 420 at which the payment is processed in accordance with non-automatic processing (comparable to step 330 in FIG. 5 when a determination has been made that the invoice does not satisfy rules for automatic processing). For example, such processing may include the need for the buyer to approve the invoice and manually initiate payment as described above with respect to conventional payment systems. In such case, there no longer being a basis to apply automatic processing, the payment would be processed in accordance with conventional non-automatic processing.

At step 430, a cancelation second notification is generated to be sent to at least the vendor, and preferably to both the vendor and buyer. The cancelation notification would provide notice to the buyer and vendor that the invoice has been withdrawn from the automatic processing. At step 440, the cancelation second notification is sent to the buyer and vendor. For example, the processor 40 of the automatic payment system 10 may be configured to generate such second notification and transmit the cancelation second notification to the buyer or vendor workstations, or suitable vendor or buyer devices. The cancelation second notification also may be transmitted via the network interface 21 to the buyer and vendor devices via the network 20.

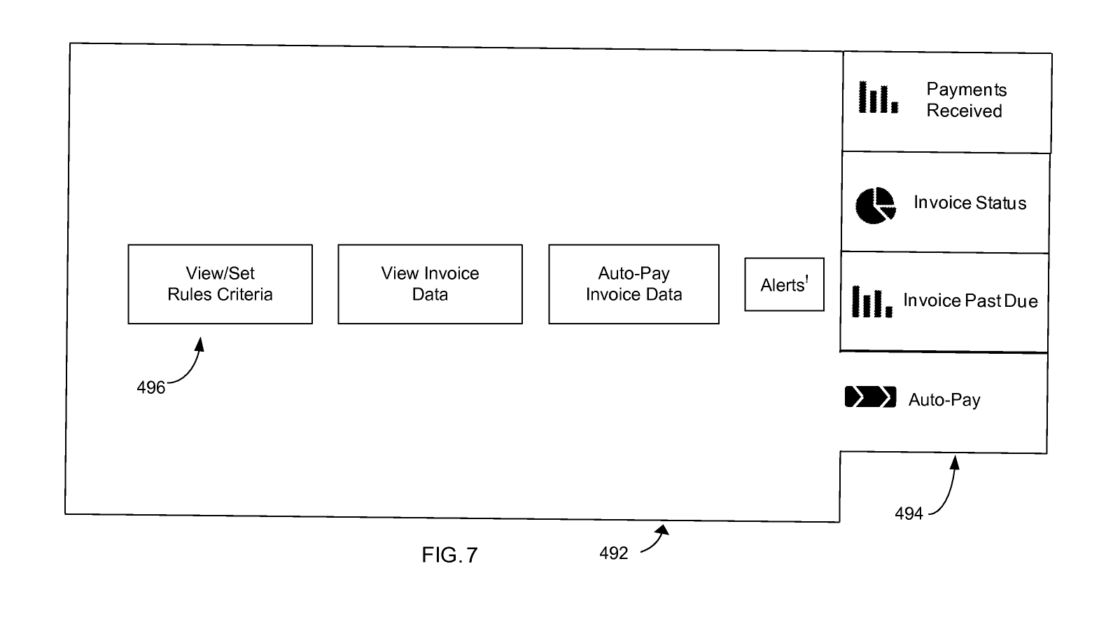

FIG. 7 depicts an exemplary graphical user interface (GUI) 492 for use in connection with an invoice payment system. The GUI particularly is suitable for use by vendors or buyers to set applicable rules for automatic payment processing, and otherwise monitor the invoice processing. The GUI 492 may be generated by a service provider operating the invoice and payment system 9 in conjunction with the automatic payment system 10. For example, the processor 40 may be configured to render display data, using conventional rendering techniques, regarding various invoice information. The display data may be transmitted via the network interface 21, and thereby accessible by a buyer or vendor respectively using a buyer or vendor workstation via the network 20. In such a system, the display data would be rendered on a display of the buyer or vendor workstation. Inputs may be provided to the GUI via any suitable input device utilized in connection with the workstation, such as a keyboard, mouse, stylus, touch screen, voice commands, and various others as are known in the art of computer based GUIs. The GUI 492 may include category information tabs 494 that pertain to various aspects of invoicing. One such exemplary category tab is “Auto-Pay” for use in connection with the various automatic payment processing features described herein. It will be appreciated that the GUI of FIG. 7 is an example, and the format and content of the GUI may be varied.

In the example of FIG. 7, the “Auto-Pay” tab has been selected for usage. Within the GUI, a variety of exemplary command buttons 496 may be provided for a buyer or vendor using the auto-Pay feature. For example, there may be a command button for “View/Set Rules Criteria”. Selecting such button in the GUI may open a sub-GUI page or window that would permit a buyer or vendor to view and enter a variety of rules for automatic payment processing as described above.

Another command button may be “View Invoice Data”. Selecting such button in the GUI may open a sub-GUI page or window that would permit a buyer or vendor to view a variety of invoice data as described above. For example, such portion of the GUI may permit access to the invoice records, such as the invoice records 162 and related invoice objects 166 as depicted in FIGS. 4A and 4B. On the buyer side, in the event invoices are processed other than by automatic processing, the buyer may be permitted to enter approval data and the like.

Another command button may be “Auto-Pay Invoice Data”. Selecting such button in the GUI may open a sub-GUI page or window that would permit a buyer or vendor to view a variety invoice data pertaining specifically to various invoices that have been subjected to automatic payment processing.

Another command button may be “Alerts”. Selecting such button in the GUI may open a sub-GUI page or window that would permit a buyer or vendor to view the various notifications described above. In particular, alerts may include the notifications that an invoice has been subjected to automatic payment processing. On the buyer side, the sub-GUI for alerts may permit the buyer to act on an alert by entering a withdrawal command to remove an invoice from automatic processing prior to the payment initiation date. In such case, the Alerts button also may provide notice of and access to the described cancelation second notifications that an invoice has been withdrawn from automatic processing. In the example of FIG. 7, the alerts button includes a symbol “!”. Such a symbol or comparable may provide notice to a buyer or vendor that new alerts have been received or are present that may be subject to action (for example, potential withdrawal command). Other forms of alert notice also may be provided. In addition to various potential visual alerts (e.g., symbols, flashing light or LED, etc.), audible alerts in the form of various alert tones also may be provided so a vendor/buyer user is provided notice of receiving an alert even when the vendor/buyer user is not viewing the GUI at the precise time the alert is received. As referenced above, alerts (whether visual or audible) may be transmitted to various electronic devices, and particularly mobile devices (e.g., laptop computers, tablets and tablet computers, smart phones, etc.), so that a buyer or vendor user can receive the alerts by numerous means. Such portable devices also may permit opening the sub-GUI for viewing and acting on alerts. In this manner, the system permits prompt action on alerts by a buyer or vendor from a variety of devices to account for the time sensitivity of alerts.

As referenced above, it will be appreciated that the GUI of FIG. 7 is an example, and the format and content of the GUI may be varied as the buyer GUI, vendor GUI, or both.

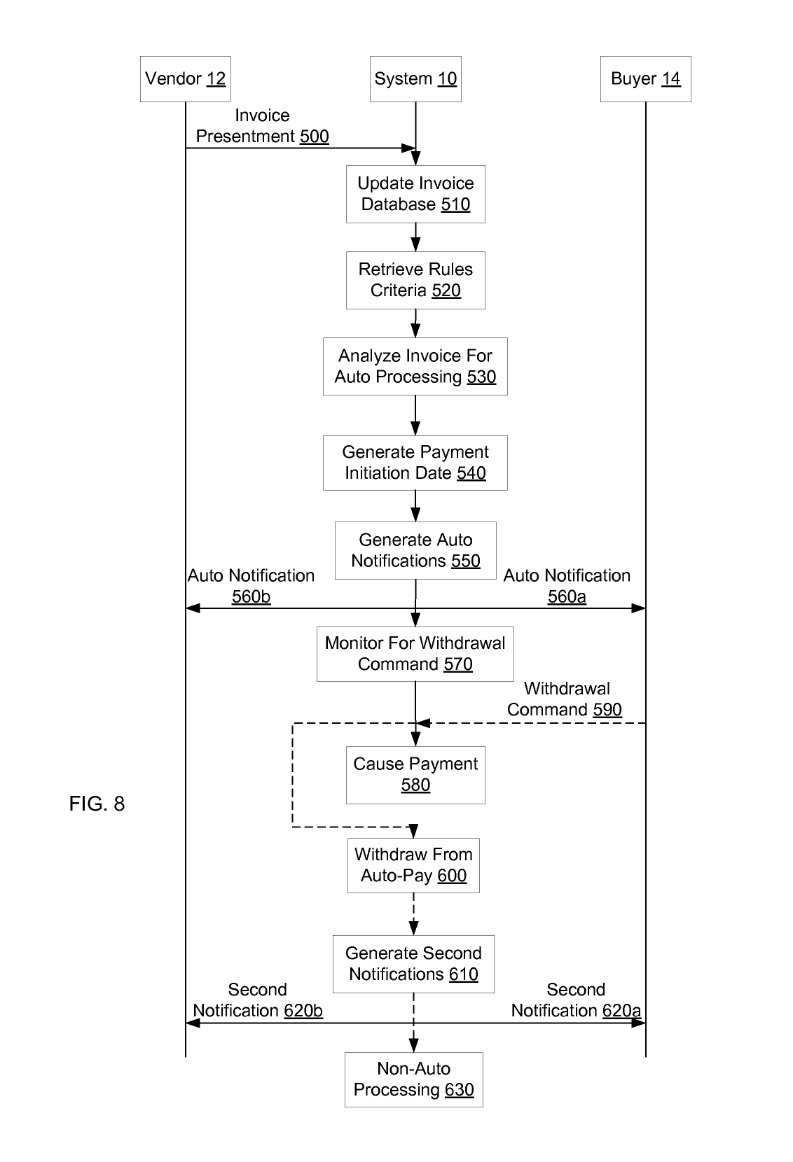

FIG. 8 is a ladder diagram depicting an exemplary embodiment of operation of the automatic payment system 10 in which a buyer 14 pays an invoice issued by a vendor 12, and the system applies the automatic processing features. In the example of FIG. 8, at step 500 the vendor electronically presents an invoice for payment by the buyer. The invoice presentment is received by the automatic payment system 10, which updates the invoice database at step 510 to indicate the status of the invoice as being received (see also FIG. 4A, block 168).

At step 520, the automatic payment system 10 retrieves the rules criteria, and at step 530 analyzes the invoice to determine whether automatic processing of the presented invoice is to be applied. When automatic processing is to be applied, at step 540 the system automatically sets the payment initiation date. At step 550 notifications (i.e., alerts) are generated that the invoice is subject to automatic processing, and the notifications are transmitted to the buyer and vendor at steps 560a and 560b. At step 570, the system monitors for potential receipt of a withdrawal command signal from the buyer.

It is intended that in most cases, the automatic processing will proceed without interruption from the buyer. In such case, at step 580, the automatic payment system 10 causes the invoice payment system 9 (see FIG. 1) to process the payment by initiating the payment automatically on the set payment initiation date.

Alternatively, at step 590 the system may receive a withdrawal command from the buyer. In such case, at step 600 the automatic payment system 10 withdraws the invoice from automatic processing. At step 610, cancelation second notifications are generated that the invoice has been removed from automatic processing, and the second notifications are transmitted to the buyer and vendor at steps 620a and 620b At step 630, automatic payment system 10 causes the invoice be processed by a suitable form of conventional non-automatic processing. Steps 590-630 are shown with dotted lines in FIG. 8, because it is intended that withdrawal from automatic processing should be a relatively rare occurrence.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. An automatic invoice payment system comprising:
a database stored on a non-transitory computer readable medium, the database including a plurality of records, each record corresponding to an invoice issued by a vendor for payment from a buyer;
a network interface configured to receive presented invoices from multiple vendors for payment by multiple buyers, wherein the presented invoices are stored in the database; and
a processor configured to associate each invoice that is presented from a vendor with a buyer for payment, and to provide electronic access to one or more of the invoices by an associated buyer; and
wherein the processor further is configured to analyze each invoice that has been presented to determine whether the presented invoice satisfies one or more predetermined rules, and when the processor determines that the presented invoice satisfies the one or more predetermined rules, to automatically set a payment initiation date upon which payment of the presented invoice is to be automatically initiated.

2. The automatic invoice payment system of claim 1, wherein the one or more predetermined rules comprises historical performance data associated with invoices that are comparable to the presented invoice based on predefined criteria.

3. The automatic invoice payment system of claim 2, wherein the one or more predetermined rules includes that the presented invoice is a repetitive invoice presented at a time based on a preset periodic time period as to which the comparable invoices were presented.

4. The automatic invoice payment system of claim 2, wherein the one or more predetermined rules includes that the presented invoice is within a set variation in amount as compared to the comparable invoices.

5. The automatic invoice payment system of claim 1, wherein the one or more predetermined rules includes at least one of that the presented invoice is within a set variation in amount, or satisfies a set threshold amount.

6. The automatic invoice payment system of claim 1, wherein the one or more predetermined rules includes that the presented invoice pertains to at least one of an approved product or service.

7. The automatic invoice payment system of claim 6, wherein the one or more predetermined rules includes that the presented invoice pertains to a quantity of the approved product or service within a prescribed amount.

8. The automatic invoice payment system of claim 1, wherein the one or more predetermined rules includes that the presented invoice has been presented within a specified number of days of the delivery of a product or service.

9. The automatic invoice payment system of claim 1, wherein the one or more predetermined rules includes that the presented invoice satisfies one or more criteria that operate to validate the invoice.

10. The automatic invoice payment system of claim 9, wherein the one or more validation criteria include at least one of validating the accuracy of an invoice calculation pertaining to the presented invoice, verifying that the presented invoice matches a corresponding purchase order, or verifying that the presented invoice is not a duplicate.

11. The automatic invoice payment system of claim 1, wherein the one or more predetermined rules are stored in the database, and the processor is configured to access the one or more predetermined rules from the database.

12. The automatic invoice payment system of claim 1, wherein the processor further is configured to generate a payment processing signal and transmit such signal via the network interface to an electronic invoice payment system for executing the payment automatically on the set payment initiation date.

13. The automatic invoice payment system of claim 1, wherein the processor further is configured to generate a notification that the payment initiation date has been set, and to transmit the notification to at least the buyer via the network interface.

14. The automatic invoice payment system of claim 13, wherein the processor is configured to generated the notification by extracting buyer information from the presented invoice.

15. The automatic invoice payment system of claim 14, wherein the extracted information comprises at least one of a buyer identity or buyer electronic address.

16. The automatic invoice payment system of claim 1, wherein the processor further is configured to monitor for receipt of a withdrawal command signal from the buyer.

17. The automatic invoice payment system of claim 16, wherein the processor further is configured, when a withdrawal command signal is received from the buyer, to cancel the payment initiation date.

18. The automatic invoice payment system of claim 17, wherein the processor further is configured to generate a cancelation notification that the payment initiation date has been canceled, and to transmit the cancelation notification to at least the vendor via the network interface.

19. The automatic invoice payment system of claim 16, wherein the processor further is configured, when a withdrawal command signal is not received from the buyer before the set payment initiation date, to generate a payment processing signal and transmit such signal via the network interface to an electronic invoice payment system for executing the payment automatically on the set payment initiation date.

20. The automatic invoice payment system of claim 1, wherein providing access to the buyer comprises providing access to an electronic file containing invoices from multiple vendors.

21. The automatic invoice payment system of claim 1, wherein the processor associates each presented invoice with a buyer by extracting buyer information from the presented invoice.

22. An electronic invoice and payment system comprising:
the automatic invoice payment system of claim 1, and
an electronic invoice payment system configured to execute the payment automatically on the set payment initiation date when the processor determines that the presented invoice satisfies the one or more predetermined rules.

23. A method of automatically processing invoice payments comprising the steps of:
storing on a non-transitory computer readable medium a database including a plurality of records, each record corresponding to an invoice issued by a vendor for payment from a buyer;
receiving over a network interface presented invoices from multiple vendors for payment by multiple buyers, wherein the presented invoices are stored in the database; and
providing an automatic payment application on a non-transitory computer readable medium, which when executed by a processor performs the steps of:
associating each invoice that is presented from a vendor with a buyer for payment;
providing electronic access to one or more of the invoices by an associated buyer;
analyzing each invoice that has been presented to determine whether the presented invoice satisfies one or more predetermined rules; and
when the presented invoice is determined to satisfy the one or more predetermined rules, automatically setting a payment initiation date upon which payment of the presented invoice is to be automatically initiated.

24. The method of automatically processing invoice payments of claim 23, wherein the automatic payment application when executed by the processor further performs the steps of:
generating a notification that the payment initiation date has been set;
transmitting the notification to at least the buyer via the network interface;
monitoring for receipt of a withdrawal command signal from the buyer; and
when a withdrawal command signal is received from the buyer, canceling the payment initiation date.

25. The method of automatically processing invoice payments of claim 24, wherein the automatic payment application when executed by the processor further performs the steps of: when a withdrawal command signal is not received from the buyer before the set payment initiation date, generating a payment processing signal and transmitting such signal via the network interface to an electronic invoice payment system for executing the payment automatically on the set payment initiation date.
